(19) United States
(12) Patent Application Publication
(10) Pub. No.: US 2012/0162269 A1
(43) Pub. Date: Jun. 28, 2012

(54) Transparent Display Active Backlight

(75) Inventors: David D. Bohn, Fort Collins, CO (US); Derek Leslie Knee, Fort Collins, CO (US); Rod G. Fleck, Bellevue, WA (US)

(73) Assignee: Microsoft Corporation, Redmond, WA (US)

(21) Appl. No.: 12/977,959

(22) Filed: Dec. 23, 2010

(51) Int. Cl. G09G 3/36; G09G 5/10; F21V 7/22

(52) U.S. Cl. 345/690; 362/611; 345/102

(57) ABSTRACT

In embodiments of a transparent display active backlight, a light guide is operable as a transparent panel, and a light source generates light that the light guide reflects within the light guide. An electrowetted panel of the active backlight has electrowetted cells that are each operable to direct the reflected light from the light guide to illuminate a display panel of a display device. Each of the electrowetted cells are further operable for transparency when activated, and each of the electrowetted cells can be individually controlled.

### BACKGROUND

Mobile phones and portable devices that display information when open or closed are typically implemented with two displays. For example, a mobile phone may have a larger, primary display for use when the device is open, and a smaller, secondary display on the back of the device to display the current time or a notification of an incoming call. The current flip, slide, or swivel type of phone devices allow a user to interact with all of the device functions when the primary display is open. However, many of the device functions may be limited or disabled when the primary display is closed over the device and/or when a smaller, secondary display is in use. Additionally, users typically want the smallest possible device to conveniently carry in a pocket or purse, but also want larger user interface surfaces for a primary display, keypad, and potentially a secondary display. Some tablet notebook computers and/or phones that have a single display may be used when in an open or closed position, but need relatively complex rotating hinges and hardware components to position the display screen for use while open or closed.

### SUMMARY

This summary is provided to introduce simplified concepts of a transparent display active backlight that are further described below in the Detailed Description. This summary is not intended to identify essential features of the claimed subject matter, nor is it intended for use in determining the scope of the claimed subject matter.

A transparent display active backlight is described. In embodiments, a light guide is operable as a transparent panel, and a light source generates light that the light guide reflects within the light guide. An electrowetted panel of the active backlight has electrowetted cells that are each operable to direct the reflected light from the light guide to illuminate a display panel of a display device. Each of the electrowetted cells are further operable for transparency when activated, and each of the electrowetted cells can be individually controlled.

In other embodiments, each of the electrowetted cells are operable for transparency when an electrowetted cell liquid is activated for distribution across the electrowetted cell. The transparency of the electrowetted panel is controllable based on all of the electrowetted panel, a section of the electrowetted panel, a cell of the electrowetted panel, or a group of cells of the electrowetted panel.

In other embodiments, each of the electrowetted cells correspond to a pixel of the display panel, and each of the electrowetted cells direct the reflected light to illuminate a corresponding pixel of the display panel. The electrowetted cells are operable to direct the reflected light from the light guide to illuminate the display panel when an electrowetted cell liquid forms a light extraction feature caused by surface tension in the electrowetted cell. For a light guide implemented as an edge-lit backlight panel, each of the electrowetted cells are individually controllable for uniform light distribution of the reflected light that illuminates the display panel. For example, the electrowetted cells that are closer to the light source can be configured to direct less of the reflected light to illuminate the display panel, and the electrowetted cells that are farther from the light source can be configured to direct more of the reflected light to illuminate the display panel.

### BRIEF DESCRIPTION OF THE DRAWINGS

Embodiments of a transparent display active backlight are described with reference to the following drawings. The same numbers are used throughout the drawings to reference like features and components:

FIG. 1 illustrates examples of a portable device and various embodiments of a transparent display active backlight.

FIG. 2 illustrates an example transparent display assembly in accordance with one or more embodiments.

FIG. 3 illustrates an example of a transparent display active backlight in accordance with one or more embodiments.

FIG. 4 illustrates example method(s) of a transparent display active backlight in accordance with one or more embodiments.

FIG. 5 illustrates various components of an example device that can implement embodiments of a transparent display active backlight.

### DETAILED DESCRIPTION

Embodiments of a transparent display active backlight are described. A portable device, such as a mobile phone or computer device, includes a display device that can be controlled for transparent and non-transparent display. The display device includes various display panels and surfaces that are assembled between front and back display surfaces of the display device, and different combinations of the display panels and surfaces may be utilized to implement a transparent display.

A transparent display active backlight is implemented with a light source, and with a light guide that reflects light generated by the light source within the light guide, such as in a TIR (total internal reflection) light guide. The active backlight also includes an electrowetted panel that is coupled or positioned proximate the light guide. In embodiments, each of the electrowetted cells correspond to a pixel in a display panel of the display device, and each of the electrowetted cells direct the reflected light to illuminate a corresponding pixel of the display panel.

An electrowetted cell is operable to direct the reflected light from the light guide to illuminate the display panel when the electrowetted cell liquid forms a light extraction feature caused by surface tension in the electrowetted cell. For example, the electrowetted cell liquid forms as a bead (e.g., the light extraction feature) when the electrowetted cell is not activated. A refraction angle of the reflected light changes with the shape of the bead that is created in the electrowetted cell, which allows the light to exit the light guide and illuminate the display panel.

Each of the electrowetted cells are further operable for transparency when activated. An electrowetted cell is operable for transparency when an electrowetted cell liquid is activated for distribution across the electrowetted cell. The electrowetted cell liquid is approximately flat when distributed across the electrowetted cell and acts as a TIR surface to reflect the light along within the light guide. The electrowetted cells of the electrowetted panel are individually controllable, and transparency of the panel is controllable based on whether an electrowetted cell is open or closed.

Each of the electrowetted cells in the electrowetted panel are also individually controllable for uniform light distribution of the reflected light that illuminates the display panel. An edge-lit display may appear brighter along the edge with the light source, and appears darker on the opposite edge of the display. In an implementation of the electrowetted panel, the electrowetted cells that are closer to the light source can be configured to direct less of the reflected light to illuminate the display panel, and the electrowetted cells that are farther from the light source can be configured to direct more of the reflected light to illuminate the display panel. The uniform light distribution also improves brightness and color uniformity across the display panel.

While features and concepts of the described systems and methods for a transparent display active backlight can be implemented in any number of different environments, systems, devices, and/or various configurations, embodiments of a transparent display active backlight are described in the context of the following example devices, systems, and configurations.

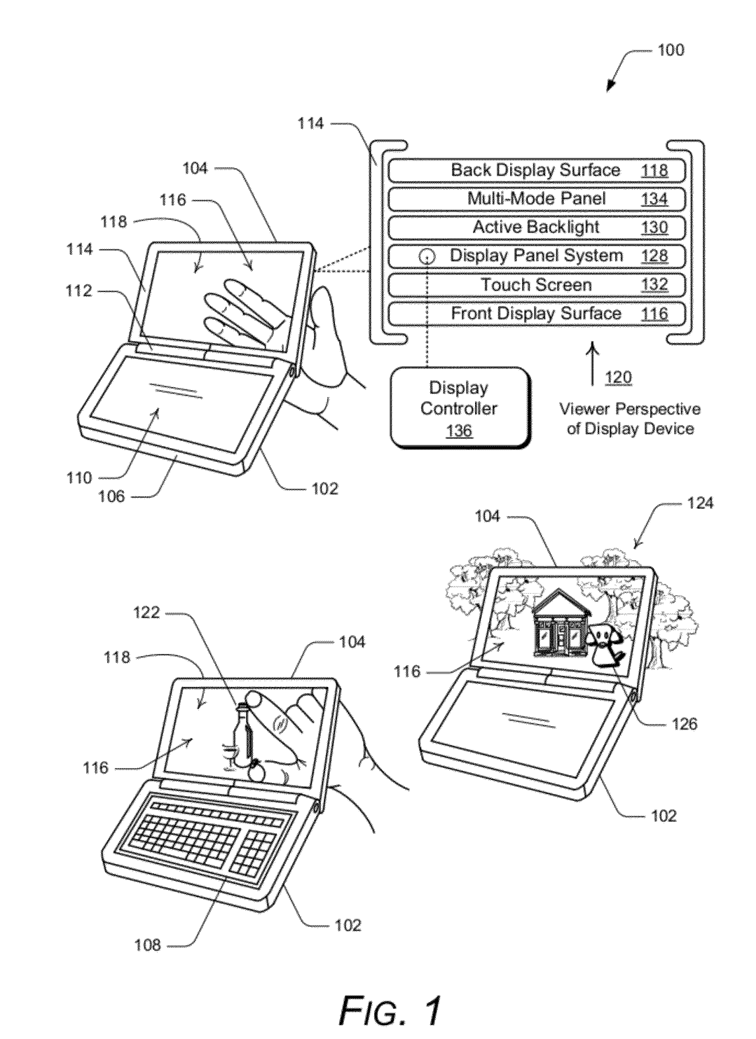

FIG. 1 illustrates examples 100 of a portable device 102 in accordance with embodiments of a transparent display active backlight. The portable device includes a display device 104 and a handheld base 106 that may include a physical keyboard (shown at 108) or an additional display device 110 as an integrated component of the portable device. The additional display device may be utilized to display text, graphics, images, user interfaces, and/or a virtual keyboard, such as when an implementation of a portable device does not include a physical keyboard. In the examples, the display device 104 is movably coupled at 112 to the handheld base of the portable device, such as with a rotating hinge, slide track, flip mechanism, or other coupling device. The display device can open and close over the handheld base, such as when folded, slid, or flipped closed over the additional display device, folded around to the back of the handheld base, or any position in-between approximately zero degrees (0°) and three-hundred sixty degrees (360°) relative to the handheld base.

The display device 104 includes a display housing 114 that supports various display panels and surfaces that may be utilized to assemble the display device. In this example, the display device includes a front display surface 116, and includes a back display surface 118. The front display surface and the back display surface are viewable from opposite sides of the display device. A user of the portable device 102 may generally view the display device 104 through the front display surface 116, shown for reference as a viewer perspective of the display device at 120.

A displayed image 122 may be viewable through the front and back display surfaces, and as illustrated, the display device 104 is transparent. As described herein, the transparency of a display device may be a percentage of transparency as measured with light detection equipment and/or as visually determined or perceived by a user when viewing an environment as seen through the various display panels and surfaces of the display device.

In the illustrated examples, a hand may be viewable through the front and back display surfaces of the display device, such as when viewed through the front of the display device. An environment 124 behind the display device can also be viewable through the front and back display surfaces of the display device, and a displayed image may appear projected into the environment for an augmented view of reality. For example, a displayed image 126 of the dog may appear projected into the environment 124 that includes trees and a building behind the display device and viewable through the front and back display surfaces of the display device.

In addition to the front display surface 116 and the back display surface 118, the display device 104 includes a display panel system 128 that is located between the front and back display surfaces. The display panel system is implemented to display images that are then viewable through the front and/or back display surfaces of the display device. The display device includes an active backlight 130 that illuminates the display panel for image display. The active backlight includes a light source and a light guide that is operable as a transparent panel that reflects light generated by the light source within the light guide. The active backlight also includes an electrowetted panel of electrowetted cells that are each operable to direct the reflected light from the light guide to illuminate a display panel, and each of the electrowetted cells are further operable for transparency when activated.

The display device may also include a touch screen 132 that is located between the front and back display surfaces to sense a touch input to either of the front display surface or the back display surface. Alternatively, the display device may include a first touch screen located proximate the front display surface and a second touch screen located proximate the back display surface, and the touch screens sense touch inputs to the respective front and back display surfaces.

The display device 104 includes a multi-mode panel 134 located between the front display surface 116 and the back display surface 118. In embodiments, the multi-mode panel is operable to switch on and off, such as to prevent an image from being viewable through the front display surface or the back display surface, or for transparency to permit the image being viewable through the front and back display surfaces. The multi-mode panel may be implemented to switch on and/or off the entire panel, sections of the panel, and/or individual pixels of the panel.

The display device 104 can include a display controller 136 that is implemented to control display modes of the display device for transparent and non-transparent display. The display controller can be implemented as computer-executable instructions, such as a software component, and executed by one or more processors to implement various embodiments for a transparent display. In practice, the portable device 102 is implemented with a processor (e.g., a CPU), a graphics processor (e.g., a GPU), and an internal display controller to drive display content to the display device. In the display device 104, the display panel system 128 may include the display controller 136 that drives each pixel according to the type of display at various voltages.

In various configurations, such as when the display device 104 is positioned open relative to the handheld base 106 of the portable device (e.g., as illustrated in the examples), the display controller 136 can activate the display device to prevent a displayed image from being viewable through the front display surface 116 or the back display surface 118. Alternatively, the display controller can activate the display device for transparency to permit the displayed image 122 being viewable through the front and back display surfaces. Similarly, the display controller can activate the display device for a transparent view of the environment 124, which is viewable through the display device. For example, the display controller can control and switch-on the multi-mode panel 134 of the display device to prevent a displayed image from being viewable through the back display surface, or switch-off the multi-mode panel for transparency to permit the displayed image being viewable through the back display surface.

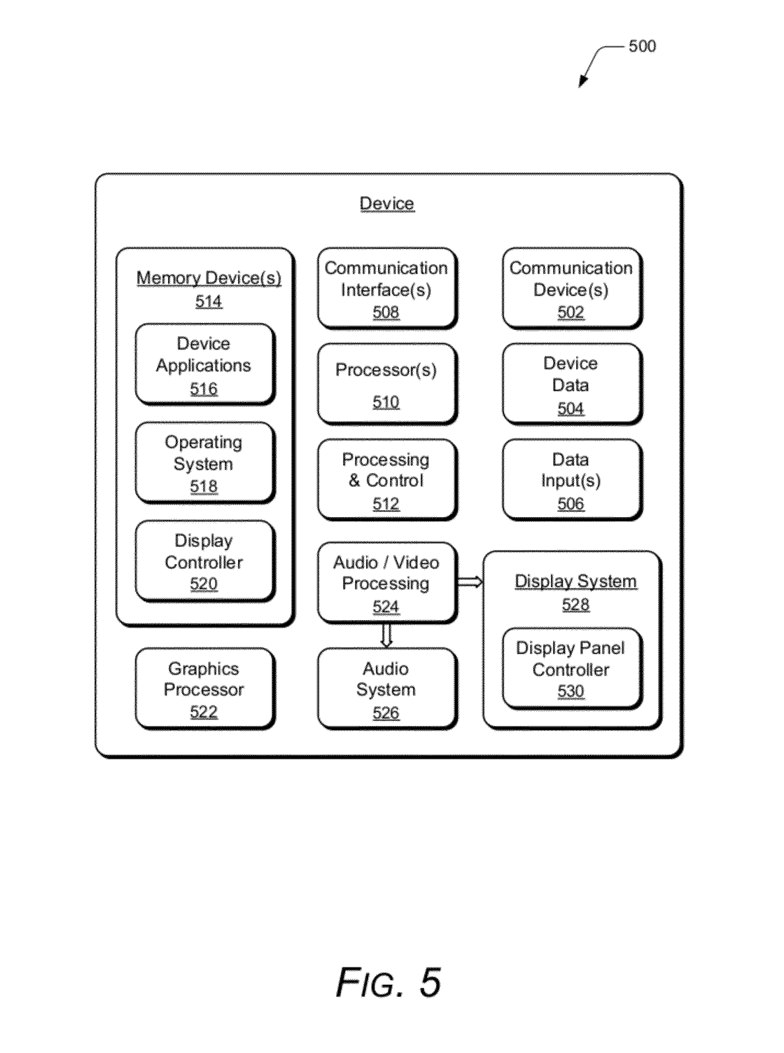

The portable device 102 may be configured as any type of client or user device that includes fixed or mobile, wired and/or wireless devices, and may be implemented as a consumer, computer (e.g., a laptop or tablet device), portable, communication, phone (e.g., a dual-display phone), appliance, gaming, media playback, and/or electronic device. The portable device can be implemented with one or more processors, data communication components, memory components, navigation components, data processing and control circuits, and a display system. Further, any of the portable devices described herein can be implemented with any number and combination of differing components as further described with reference to the example device shown in FIG. 5.

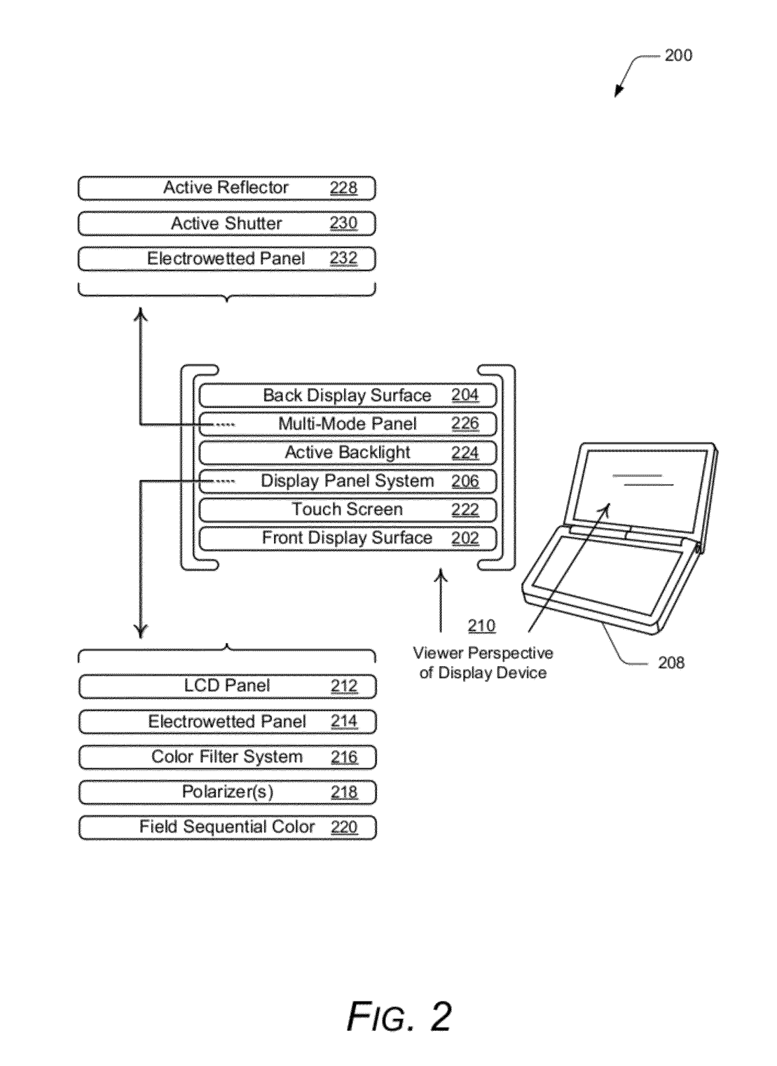

FIG. 2 illustrates an example transparent display assembly 200 that includes various display panels and surfaces as described above with reference to FIG. 1. Embodiments of a transparent display active backlight are implemented to maximize light efficiency and transparency. The transparency of a display device may be diminished, primarily due to polarizers (e.g., in an LCD implementation), color filters, and the light efficiency of a light source used to illuminate a display panel. As described above, the transparency of a transparent display may be a percentage of transparency as measured and/or as visually determined or perceived by a user when viewing through the transparent display assembly.

The transparent display assembly 200 includes a front display surface 202 and a back display surface 204. The front display surface and the back display surface are viewable from opposite sides of the transparent display assembly. In addition to the front and back display surfaces, the transparent display assembly includes a display panel system 206 that is located between the front and back display surfaces. The display panel system displays images that are viewable through the front and/or back display surfaces of the transparent display assembly. A user of a device 208 that includes the transparent display assembly may generally view the display through the front display surface 202, shown for reference as a viewer perspective of the display at 210.

In various embodiments, the display panel system 206 may include any one or combination of an LCD panel 212, an electrowetted panel 214, a color filter system 216 that may be implemented as a passive or active system, one or more polarizers 218 that may be implemented as passive or active, and/or an implementation of field sequential color 220. The LCD panel 212 can be implemented as a transparent LCD panel. An LCD implementation includes polarizers, and may include an implementation of field sequential color rather than using color filters. The color filter system 216 can be implemented for a percentage of transparency that permits an image being viewable through the display device. Similarly, the polarizers 218 can be implemented for a percentage of transparency that permits the image being viewable through the display device. In embodiments, an implementation of field sequential color 220 may be utilized in place of the color filters.

The transparent display assembly 200 also includes a touch screen 222 and an active backlight 224 that illuminates the display panel for image display. The active backlight includes a light source and a light guide that is operable as a transparent panel that reflects light generated by the light source within the light guide. The active backlight also includes an electrowetted panel of electrowetted cells that are each operable to direct the reflected light from the light guide to illuminate a display panel, and each of the electrowetted cells are further operable for transparency when activated.

A multi-mode panel 226 of the transparent display assembly 200 is located between the front display surface 202 and the back display surface 204. The multi-mode panel may be implemented to switch on and/or off the entire panel, sections of the panel, and/or individual pixels of the panel. In various embodiments, the multi-mode panel may include any one or combination of an active reflector 228, an active shutter 230, and/or an implementation of an electrowetted panel 232 (e.g., implemented as an active reflector). The active reflector and/or active shutter can be implemented to permit or prevent one side of a display from being viewable, such as through the back display surface.

The active reflector 228 and the active shutter 230 are operable to switch-on and prevent an image from being viewable through the front display surface 202 or the back display surface 204, and further operable to switch-off for transparency to permit the image being viewable through the front and back display surfaces. The active reflector 228 can be implemented as a dual-state mirror having a transparent state for transparency, and a reflective state to reflect and recycle light that is lost, such as from an illuminated light guide to illuminate the display. The active shutter 230 can be implemented as an LCD shutter that provides for variable light transmissivity based on an applied voltage. In embodiments, an electrowetting implementation of the electrowetted panel 232 does not include polarizers, and may or may not include color filters. Any of the described multi-mode panel solutions, such as an active reflector, active shutter, or electrowetted panel, can be implemented to operate on the whole panel, sections of the panel, and/or on a pixel-by-pixel basis.

Electrochromatic type materials can be utilized to implement electrically switchable, active panels, such as an active reflector and active diffuser that can be switched-off for transparency. Alternatively or in addition, other electrically switchable materials that have a high transmissivity in an open state and a high reflectance in a closed state may be utilized to implement panels and sections of a transparent display. Materials that have bi-stable properties have no active power component and may also be utilized, particularly for low power modes of a mobile device that includes an integrated transparent display.

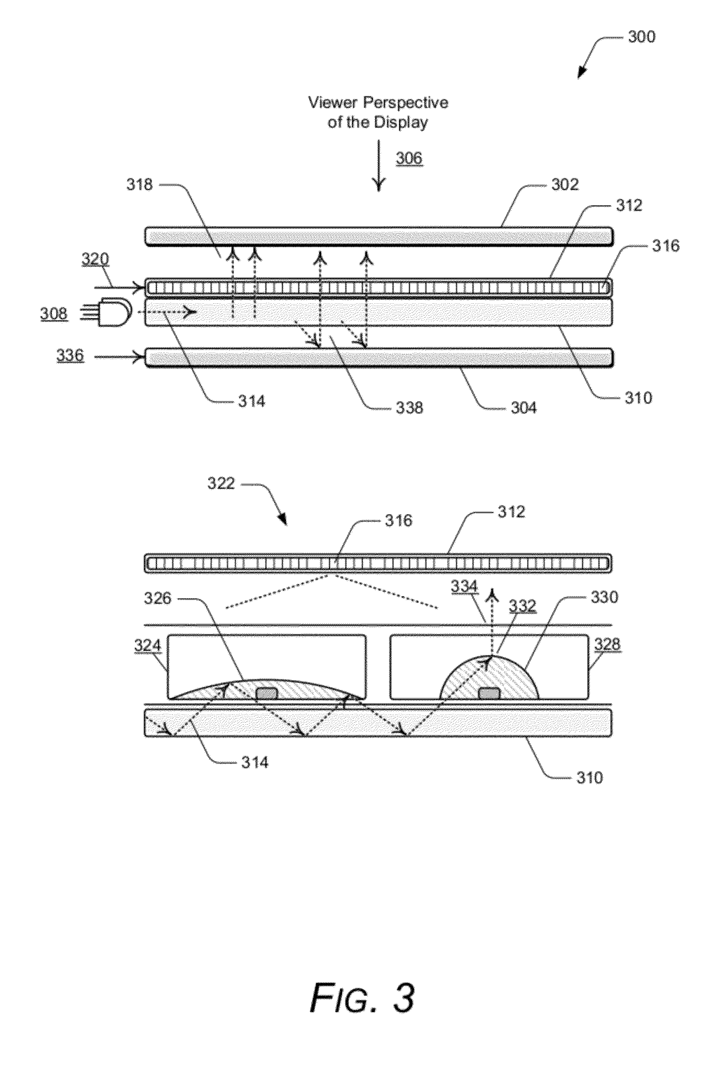

FIG. 3 illustrates an example of display components 300 in embodiments of a transparent display active backlight, which may be implemented as components of the transparent display assembly 200 described with reference to FIG. 2. The display components include a display panel 302, such as described with reference to the display panel system, as well as a multi-mode panel 304 as described with reference to the transparent display assembly shown in FIG. 2. Alternatively or in addition, the multi-mode panel 304 can be implemented as a passive reflector, such as for a non-transparent display implementation. An orientation reference at 306 indicates a viewer perspective of the display panel, such as when a user of a device that includes the display components views the display panel.

The display components also include an active backlight that is implemented with a light source 308, a light guide 310, and an electrowetted panel 312. In implementations, the light source can be a white light or separate RGB colors. In this example, the light source includes light emitting diodes (LEDs) that generate light 314 to edge-light the light guide (e.g., as an edge-lit backlight panel). The light guide is operable as a transparent panel and reflects the light within the light guide, such as in a TIR (total internal reflection) light guide.

In an implementation, the electrowetted panel 312 is coupled or positioned proximate the light guide 310. The electrowetted panel includes electrowetted cells 316 that are each operable to direct reflected light from the light guide to illuminate the display panel at 318. In embodiments, each of the electrowetted cells correspond to a pixel of the display panel, and each of the electrowetted cells direct the reflected light to illuminate a corresponding pixel of the display panel. Each of the electrowetted cells are further operable for transparency when activated, such as when activation control inputs 320 are initiated from the display controller. In an embodiment, the display panel 302 can be implemented with color filters 216 (e.g., active or passive) as described with reference to FIG. 2, and the activation control inputs 320 are utilized to control luminescence with the electrowetted cells.

A detail view 322 illustrates individual electrowetted cells 316 in the electrowetted panel 312. A first electrowetted cell 324 is shown operable for transparency when an electrowetted cell liquid 326 is activated for distribution across the electrowetted cell. The electrowetted cell liquid is approximately flat when distributed across the electrowetted cell and acts as a TIR surface to reflect the light 314 along within the light guide 310. The electrowetted cell liquid can be implemented as a reflective oil, water, or other liquid material. The electrowetted cells 316 of the electrowetted panel are individually controllable, and transparency of the panel is controllable based on whether an electrowetted cell is open or closed. Transparency of the electrowetted panel is controllable based on all of the electrowetted panel, a section of the electrowetted panel, a cell of the electrowetted panel, or a group of cells of the electrowetted panel.

A second electrowetted cell 328 is shown operable to direct the reflected light 314 from the light guide 310 to illuminate the display panel when the electrowetted cell liquid 330 forms a light extraction feature caused by surface tension in the electrowetted cell. In this example, the electrowetted cell liquid forms as a bead (e.g., the light extraction feature) when the electrowetted cell is not activated. A refraction angle at 332 of the reflected light 314 changes with the shape of the bead that is created in the electrowetted cell, which allows the light to exit the light guide at 334 and illuminate the display panel.

Each of the electrowetted cells 316 in the electrowetted panel 312 are individually controllable for uniform light distribution of the reflected light that illuminates the display panel. An edge-lit display may appear brighter along the edge with the light source, and appears darker on the opposite edge of the display. In an implementation of the electrowetted panel 312, the electrowetted cells that are closer to the light source 308 can be configured to direct less of the reflected light to illuminate the display panel, and the electrowetted cells that are farther from the light source can be configured to direct more of the reflected light to illuminate the display panel. For example, the electrowetted cells that are farther from the light source can be opened more than the electrowetted cells that are closer to the light source. Alternatively or in addition, the electrowetted cells that are farther from the light source can be designed larger than the electrowetted cells that are closer to the light source (and the surface around the smaller electrowetted cells do not absorb light in the light guide).

The uniform light distribution also improves brightness and/or color uniformity across the display panel. Light that is lost from the light guide can also be reflected and used when the multi-mode panel 304 is activated with an activation control input 336 from the display controller. When switched-on and operable as a reflector, lost light that is generated by the light source and directed away from the display panel is reflected by the multi-mode panel at 338 to further illuminate the display panel 302.

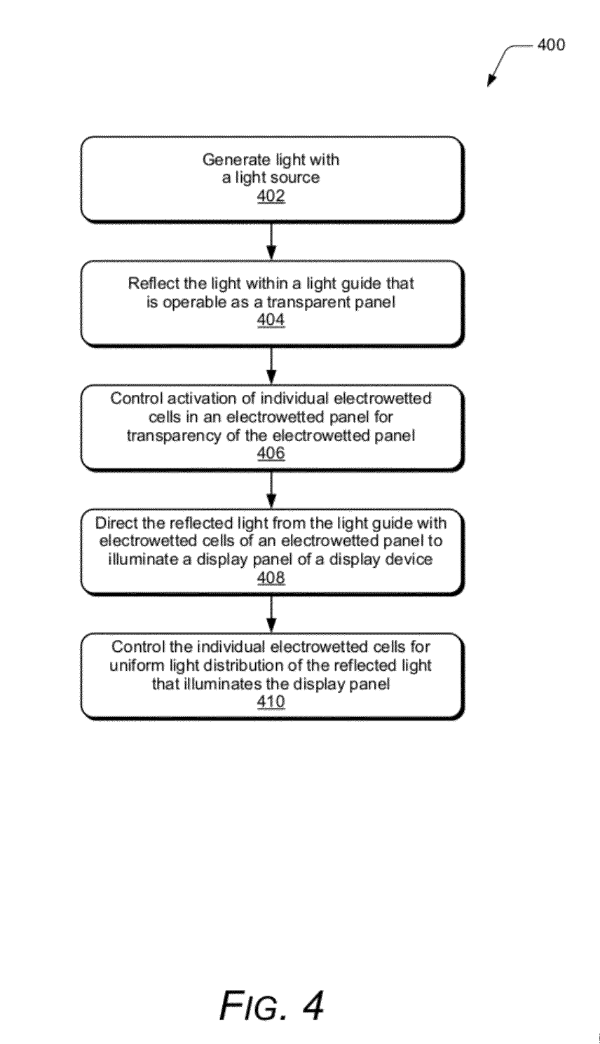

Example method 400 is described with reference to FIG. 4 in accordance with one or more embodiments of a transparent display active backlight. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

FIG. 4 illustrates example method(s) 400 of a transparent display active backlight. The order in which the method blocks are described are not intended to be construed as a limitation, and any number of the described method blocks can be combined in any order to implement a method, or an alternate method.

At block 402, light is generated with a light source. For example, the light source 308 (FIG. 3) generates light 314, which can be generated with light emitting diodes (LEDs), and the light guide 310 is edge-lit by the LEDs. At block 404, the light is reflected within the light guide that is operable as a transparent panel. For example, the light guide 310 reflects the light 314 within the light guide, such as in a TIR (total internal reflection) light guide.

At block 406, activation of electrowetted cells in an electrowetted panel are individually controlled for transparency of the electrowetted panel. For example, the display controller individually activates and controls the electrowetted cells 316 in the electrowetted panel 312 for transparency of the electrowetted panel. An electrowetted cell 324 is operable for transparency when an electrowetted cell liquid 326 in the electrowetted cell is activated for distribution across the electrowetted cell. The electrowetted cell liquid is approximately flat when distributed across the electrowetted cell and acts as a TIR surface to reflect the light 314 along within the light guide 310.

At block 408, the reflected light is directed from the light guide with electrowetted cells of an electrowetted panel to illuminate a display panel of a display device. For example, the electrowetted cells 316 of the electrowetted panel 312 direct the reflected light 314 from the light guide 310 to illuminate the display panel 302. In embodiments, each of the electrowetted cells correspond to a pixel of the display panel, and the reflected light is directed to illuminate a corresponding pixel of the display panel. An electrowetted cell 328 is operable to direct the reflected light 314 from the light guide 310 to illuminate the display panel 302 when the electrowetted cell liquid 330 in the electrowetted cell forms a light extraction feature caused by surface tension in the electrowetted cell.

At block 410, the electrowetted cells are controlled for uniform light distribution of the reflected light that illuminates the display panel. For example, the display controller individually controls activation of the electrowetted cells 316 for uniform light distribution of the reflected light 314 that illuminates the display panel. The electrowetted cells that are closer to the light source 308 can be configured to direct less of the reflected light to illuminate the display panel, and the electrowetted cells that are farther from the light source can be configured to direct more of the reflected light to illuminate the display panel.

FIG. 5 illustrates various components of an example device 500 that can be implemented as a portable device as described with reference to any of the previous FIGS. 1-4. In embodiments, the device may be implemented as any one or combination of a fixed or mobile device, in any form of a consumer, computer, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 500 includes communication devices 502 that enable wired and/or wireless communication of device data 504, such as received data, data that is being received, data scheduled for transmission, data packets of the data, etc. The device data or other device content can include configuration settings of the device, media content stored on the device, and/or information associated with a user of the device. Media content stored on the device can include any type of audio, video, and/or image data. The device includes one or more data inputs 506 via which any type of data, media content, and/or inputs can be received, such as user-selectable inputs, messages, communications, music, television content, recorded video content, and any other type of audio, video, and/or image data received from any content and/or data source.

The device 500 also includes communication interfaces 508, such as any one or more of a serial, parallel, network, or wireless interface. The communication interfaces provide a connection and/or communication links between the device and a communication network by which other electronic, computing, and communication devices communicate data with the device.

The device 500 includes one or more processors 510 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits which are generally identified at 512. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 500 also includes one or more memory devices 514 (e.g., computer-readable storage media) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like.

Computer readable media can be any available medium or media that is accessed by a computing device. By way of example, and not limitation, computer readable media may comprise storage media and communication media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. The term modulated data signal means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 514 provides data storage mechanisms to store the device data 504, other types of information and/or data, and various device applications 516. For example, an operating system 518 and a display controller 520 can be maintained as software applications with a memory device and executed on the processors. The device applications may also include a device manager, such as any form of a control application, software application, signal processing and control module, code that is native to a particular device, a hardware abstraction layer for a particular device, and so on.

The device 500 may also include a graphics processor 522, and includes an audio and/or video processing system 524 that generates audio data for an audio system 526 and/or generates display data for a display system 528. The audio system and/or the display system may include any devices that process, display, and/or otherwise render audio, video, display, and/or image data. For example, the display system includes a display panel controller 530. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device.

Although embodiments of a transparent display active backlight have been described in language specific to features and/or methods, the subject of the appended claims is not necessarily limited to the specific features or methods described. Rather, the specific features and methods are disclosed as example implementations of a transparent display active backlight.

1. An active backlight, comprising:
a light source configured to generate light;
a light guide operable as a transparent panel and configured to reflect the light within the light guide; and
an electrowetted panel having electrowetted cells each operable to direct the reflected light from the light guide to illuminate a display panel of a display device, each of the electrowetted cells further operable for transparency when activated.

2. A active backlight as recited in claim 1, wherein each of the electrowetted cells correspond to a pixel of the display panel, and wherein each of the electrowetted cells are configured to direct the reflected light to illuminate a corresponding pixel of the display panel.

3. A active backlight as recited in claim 1, wherein each of the electrowetted cells are operable for transparency when an electrowetted cell liquid in an electrowetted cell is activated for distribution across the electrowetted cell.

4. A active backlight as recited in claim 1, wherein each of the electrowetted cells are operable to direct the reflected light from the light guide to illuminate the display panel when an electrowetted cell liquid in an electrowetted cell forms a light extraction feature caused by surface tension in the electrowetted cell.

5. A active backlight as recited in claim 1, wherein the transparency of the electrowetted panel is controllable based on at least one of all of the electrowetted panel, a section of the electrowetted panel, a cell of the electrowetted panel, or a group of cells of the electrowetted panel.

6. A active backlight as recited in claim 1, wherein the light guide is an edge-lit backlight panel, and wherein each of the electrowetted cells are individually controllable for uniform light distribution of the reflected light that illuminates the display panel.

7. A active backlight as recited in claim 6, wherein the electrowetted cells that are closer to the light source are configured to direct less of the reflected light to illuminate the display panel, and wherein the electrowetted cells that are farther from the light source are configured to direct more of the reflected light to illuminate the display panel.

8. A display device, comprising:
a light guide operable as a transparent panel and configured to reflect light within the light guide;
an electrowetted panel having electrowetted cells each operable to direct the reflected light from the light guide to illuminate a display panel of the display device, each of the electrowetted cells further operable for transparency when activated; and
a memory and a processor to implement a display controller configured to individually control activation of the electrowetted cells in the electrowetted panel.

9. A display device as recited in claim 8, wherein each of the electrowetted cells correspond to a pixel of the display panel, and wherein each of the electrowetted cells are configured to direct the reflected light to illuminate a corresponding pixel of the display panel.

10. A display device as recited in claim 8, wherein each of the electrowetted cells are operable for transparency when an electrowetted cell liquid in an electrowetted cell is activated for distribution across the electrowetted cell.

11. A display device as recited in claim 8, wherein each of the electrowetted cells are operable to direct the reflected light from the light guide to illuminate the display panel when an electrowetted cell liquid in an electrowetted cell forms a light extraction feature caused by surface tension in the electrowetted cell.

12. A display device as recited in claim 8, wherein the transparency of the electrowetted panel is controllable based on at least one of all of the electrowetted panel, a section of the electrowetted panel, a cell of the electrowetted panel, or a group of cells of the electrowetted panel.

13. A display device as recited in claim 8, wherein the light guide is an edge-lit backlight panel, and wherein each of the electrowetted cells are individually controllable for uniform light distribution of the reflected light that illuminates the display panel.

14. A display device as recited in claim 13, wherein the electrowetted cells that are closer to the light source are configured to direct less of the reflected light to illuminate the display panel, and wherein the electrowetted cells that are farther from the light source are configured to direct more of the reflected light to illuminate the display panel.

15. A method, comprising:
generating light with a light source;
reflecting the light within a light guide that is operable as a transparent panel; and
directing the reflected light from the light guide with electrowetted cells of an electrowetted panel to illuminate a display panel of a display device.

16. A method as recited in claim 15, further comprising individually controlling activation of the electrowetted cells in the electrowetted panel for transparency.

17. A method as recited in claim 16, wherein each of the electrowetted cells are operable for transparency when an electrowetted cell liquid in an electrowetted cell is activated for distribution across the electrowetted cell.

18. A method as recited in claim 15, further comprising individually controlling each of the electrowetted cells for uniform light distribution of the reflected light that illuminates the display panel.

19. A method as recited in claim 15, wherein each of the electrowetted cells correspond to a pixel of the display panel, and wherein the reflected light is directed to illuminate a corresponding pixel of the display panel.

20. A method as recited in claim 15, wherein each of the electrowetted cells are operable to direct the reflected light from the light guide to illuminate the display panel when an electrowetted cell liquid in an electrowetted cell forms a light extraction feature caused by surface tension in the electrowetted cell.
